(19) United States
(12) Patent Application Publication
(10) Pub. No.: US 2024/0035319 A1
(43) Pub. Date: Feb. 1, 2024

(54) INSIDE HANDLE

(71) Applicant: TOYOTA JIDOSHA KABUSHIKI KAISHA, Toyota-shi Aichi-ken (JP)

(72) Inventors: Kazuki TAKENAKA, Nagoya-shi Aichi-ken (JP); Akira TANI, Anjo-shi Aichi-ken (JP)

(73) Assignee: TOYOTA JIDOSHA KABUSHIKI KAISHA, Toyota-shi Aichi-ken (JP)

(21) Appl. No.: 18/199,707

(22) Filed: May 19, 2023

(30) Foreign Application Priority Data
Jul. 27, 2022 (JP) 2022-119580

(51) Int. Cl. E05B 85/12

(52) U.S. Cl. CPC E05B 85/13

(57) ABSTRACT

An inside handle may include: a handle body disposed in an opening and operated by a user; and a handle base that supports the handle body such that the handle body is capable of swinging around a rotation shaft parallel to the opening between an ordinary position and an operation position. The handle body may include: a design surface disposed along the opening when the handle body is at the ordinary position; an operation surface that extends from a distal end of the design surface relative to the rotation shaft to the interior of the opening, the operation surface forming a concave portion in which a finger of the user that operates the handle body is disposed; a pair of protection walls that is positioned on both sides of the concave portion formed by the operation surface and that extends from the design surface to the interior of the opening.

### CROSS-REFERENCE TO RELATED APPLICATION

This application claims priority to Japanese Patent Application No. 2022-119580 filed on Jul. 27, 2022, incorporated herein by reference in its entirety.

### BACKGROUND

### 1. Technical Field

A technology disclosed in the present specification relates to an inside handle that is provided on a door of a vehicle.

### 2. Description of Related Art

Japanese Unexamined Patent Application Publication No. 2016-132950 describes an inside handle that is provided on a door of a vehicle. In the inside handle, a handle body that is operated by a user is supported by a handle base, so as to be capable of swinging.

### SUMMARY

The inside handle is sometimes disposed in an opening that is formed on an interior surface of the door. This type of inside handle is operated by the user from an ordinary position where the handle body is contained in the interior of the opening to an operation position where the handle body is displaced to the exterior of the opening. In that case, when the handle body is returned from the operation position to the ordinary position, a finger of the user that operates the handle body can be caught between the handle body and the opening. The present specification provides a technology that can solve the above problem.

The technology disclosed in the present specification is embodied as an inside handle that is provided on a door of a vehicle. As a first aspect, the inside handle may include: a handle body that is disposed in an opening formed on an interior surface of the door and that is operated by a user; and a handle base that supports the handle body such that the handle body is capable of swinging around a rotation shaft parallel to the opening between an ordinary position in the opening and an operation position where the handle body is displaced to the exterior of the opening. The handle body may include: a design surface that is disposed along the opening when the handle body is at the ordinary position; an operation surface that extends from a distal end of the design surface relative to the rotation shaft to the interior of the opening, the operation surface forming a concave portion in which a finger of the user that operates the handle body is disposed; and a pair of protection walls that is positioned on both sides of the concave portion formed by the operation surface and that extends from the design surface to the interior of the opening.

In the above inside handle, when the user operates the handle body, the finger of the user is disposed in the concave portion formed in the handle body. The protection walls that extend from the design surface of the handle body to the interior of the opening are provided on both sides of the concave portion. In this configuration, even when the handle body is operated to the operation position and the concave portion of the handle body is displaced to the exterior of the opening, it is possible to avoid a gap by which the finger of the user can be caught, from being formed between the handle body and the opening.

As a second aspect, in the above first aspect, distal ends of the protection walls relative to the rotation shaft may have an arc shape centered at the rotation shaft. In this configuration, it is possible to avoid the gap from being formed between the handle body and the opening, regardless of the position of the swinging of the handle body.

As a third aspect, in the above first aspect or second aspect, the interior surface of the door may include a first region and a second region that protrudes relative to the first region, and the opening of the interior surface may be formed across the first region and the second region. In this case, the handle body may be disposed at a portion that is of the opening and that is positioned in the first region, and the concave portion formed by the operation surface of the handle body may be opened toward a portion that is of the opening and that is positioned in the second region. In this configuration, when the user operates the handle body, the user can easily put the finger into the concave portions.

As a fourth aspect, in the above first aspect, the opening formed on the interior surface may be opened upward, and the rotation shaft may be parallel to the right-left direction of the vehicle. In this case, it is possible to dispose the inside handle on an armrest portion provided on the door, for example.

As a fifth aspect, in any one of the above first to fourth aspects, the inside handle may further include a lock knob that is supported so as to be capable of rotating between a lock position and an unlock position. In this case, a surface of the lock knob may include a first range and a second range that have different friction coefficients from each other. In addition, when the lock knob is at the lock position, the first range and the second range may be exposed such that the first range is positioned on one side relative to the second range, and when the lock knob is at the unlock position, the first range and the second range may be exposed such that the first range is positioned on the other side relative to the second range. In this case, the distribution of the friction coefficient of the exposed surface of the lock knob changes depending on the position of the lock knob. Thereby, the user can recognize the position of the lock knob by tactile sense, without visually recognizing the lock knob. Further, the range having the higher friction coefficient is constantly exposed regardless of the position of the lock knob, and therefore it is hard for finger slippage to occur at the time of operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a side door 2;

FIG. 2 is a diagram showing an inside handle 10 when a handle body 12 is at an operation position;

FIG. 3 is a side view showing the inside handle 10 when the handle body 12 is at the operation position;

FIG. 4 is a diagram showing the inside handle 10 when the handle body 12 is at an ordinary position and a lock knob 24 is at an unlock position;

FIG. 5 is a side view showing the inside handle 10 when the handle body 12 is at the ordinary position and the lock knob 24 is at the unlock position; and

FIG. 6 is a diagram showing the inside handle 10 when the handle body 12 is at the ordinary position and the lock knob 24 is at a lock position.

### DETAILED DESCRIPTION OF EMBODIMENTS

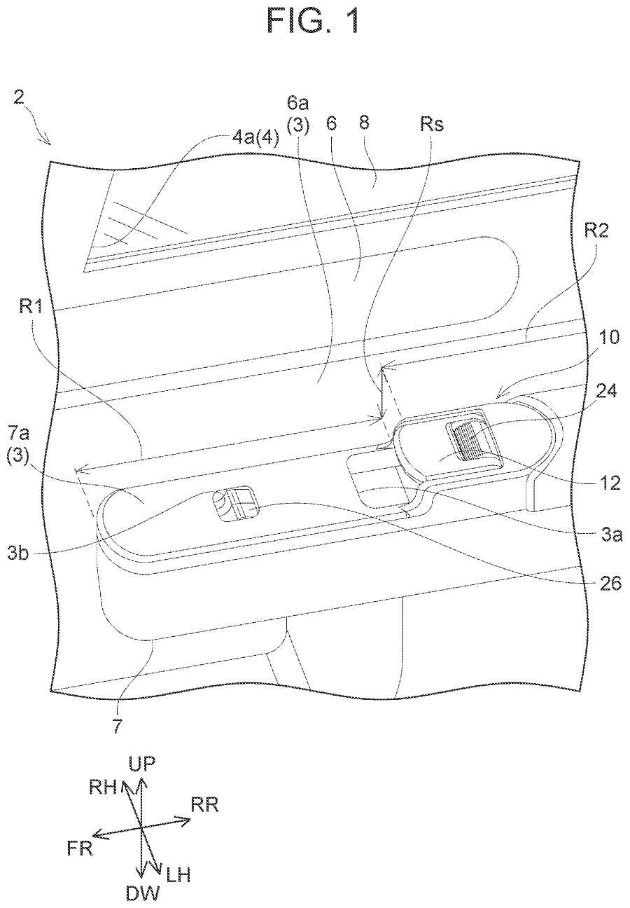

An inside handle 10 in an embodiment will be described with reference to the drawings. The inside handle 10 in the embodiment is provided on a side door 2 of a vehicle. FIG. 1 shows a diagram of the side door 2 of the vehicle as viewed from a vehicle cabin side. A user in the vehicle can open the side door 2 to get out, by operating the inside handle 10. In the drawings, directions in the inside handle 10 conform to directions when the inside handle 10 is attached to the vehicle, that is, directions in the vehicle. In the drawings, a direction FR indicates the forward direction of the front-rear direction of the vehicle, and a direction RR indicates the rearward direction of the front-rear direction of the vehicle. Further, a direction LH indicates the leftward direction of the right-left direction of the vehicle, and a direction RH indicates the rightward direction of the right-left direction of the vehicle. Further, a direction UP indicates the upward direction of the up-down direction of the vehicle, and a direction DW indicates the downward direction of the up-down direction of the vehicle.

As shown in FIG. 1, the side door 2 includes a door body 4 having a window opening 4a, an interior panel 6 (also called a trim) put on the door body 4, and a window glass 8. The interior panel 6 is disposed below the window opening 4a. The window glass 8 is attached to the window opening 4a.

An armrest portion 7 is provided on the interior panel 6. The armrest portion 7 is formed so as to protrude from a principal surface 6a of the interior panel 6 toward a vehicle inside. The armrest portion 7 has a shape that is long in the front-rear direction. The armrest portion 7 includes a placement surface 7a. When the user sits on a seat in the vehicle cabin, the user can place a user's forearm along the longitudinal direction of the placement surface 7a of the armrest portion 7, from above. The armrest portion 7 may be formed as a separate member from the interior panel 6, or may be integrally formed. The placement surface 7a of the armrest portion 7 includes a first region R1, a second region R2 and a step region Rs. The second region R2 protrudes upward relative to the first region R1. The step region Rs is positioned between the first region R1 and the second region R2, and is inclined in the up-down direction.

The side door 2 includes an interior surface 3. An opening 3a is formed on the interior surface 3. The opening 3a is opened upward. The inside handle 10 is disposed so as to be exposed from the opening 3a. The interior surface 3 described in the present specification means a surface that is visually recognized by the user on the vehicle cabin side of the side door 2. That is, the interior surface 3 includes the whole surface on the vehicle cabin side of the interior panel 6. The whole surface on the vehicle cabin side of the interior panel 6 includes the principal surface 6a of the interior panel 6 and the placement surface 7a of the armrest portion 7. In the embodiment, the opening 3a in which the inside handle 10 is disposed is formed across the first region R1 and second region R2 of the placement surface 7a. That is, in the embodiment, the inside handle 10 is disposed on the placement surface 7a of the armrest portion 7. However, without being limited to the placement surface 7a of the armrest portion 7, the inside handle 10 may be disposed at another portion of the interior surface 3 of the side door 2. Although not particularly limited, a second opening 3b is provided in the first region R1 of the interior surface 3. The second opening 3b is opened upward. A power window switch 26 is provided in the second opening 3b. The power window switch 26 is a switch for an opening-closing operation of the window glass 8 of the side door 2.

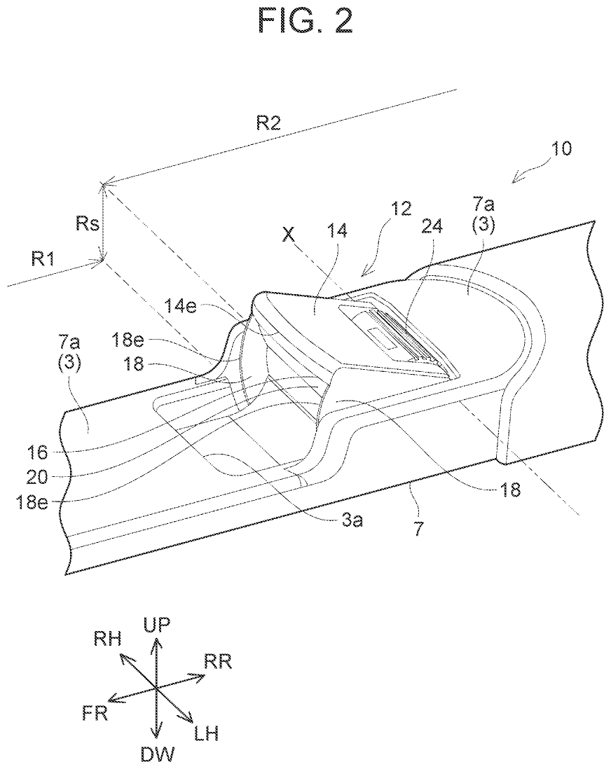

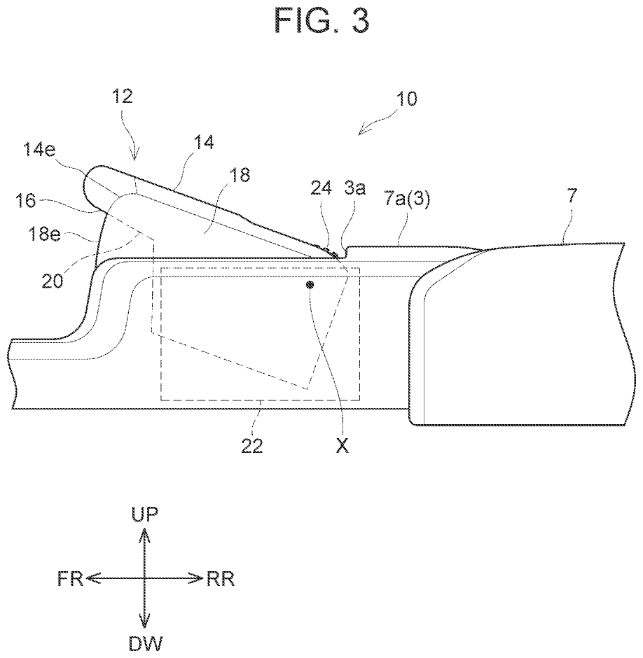

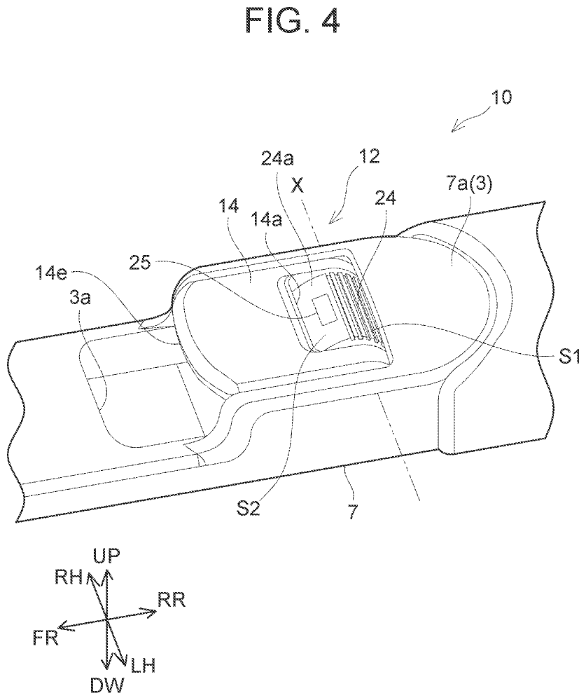

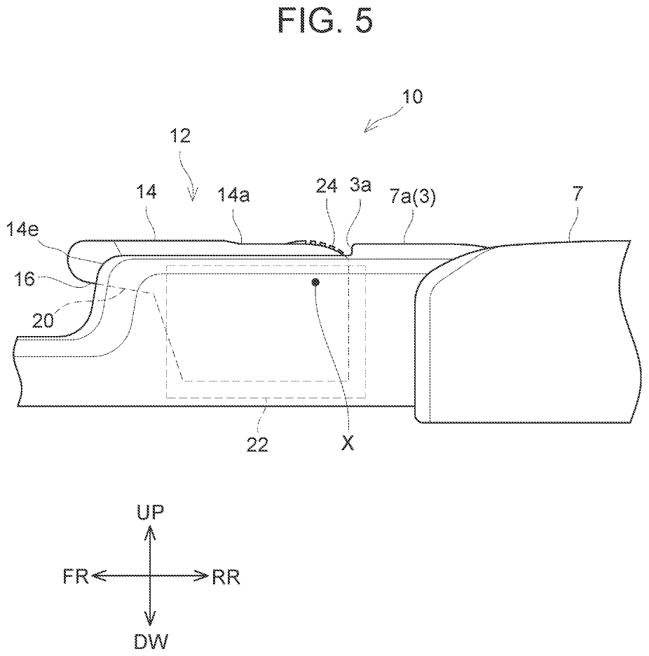

Details of the configuration of the inside handle 10 will be described with reference to FIG. 2 to FIG. 6. As shown in FIG. 2 to FIG. 5 (mainly FIG. 2 and FIG. 3), the inside handle 10 includes a handle body 12, a handle base 22 and a lock knob 24. The handle body 12 is disposed in the opening 3a on the placement surface 7a of the armrest portion 7. The handle body 12 is operated by the user. The handle base 22 supports the handle body 12 such that the handle body 12 is capable of swinging around a rotation shaft X between an ordinary position and an operation position. The ordinary position is a position where the handle body 12 is contained in the opening 3a (see FIG. 4 and FIG. 5). The operation position is a position where the handle body 12 is displaced from the ordinary position to the exterior of the opening 3a (see FIG. 2 and FIG. 3). The rotation shaft X is disposed parallel to the opening 3a. In the embodiment, the rotation shaft X extends parallel to the right-left direction (that is, the vehicle width direction). Accordingly, the handle body 12 is swung by the user in the up-down direction. The handle body 12 is connected to a lock mechanism of the side door 2 through a control cable (not illustrated). When the handle body 12 is displaced from the ordinary position to the operation position, a latch of the lock mechanism is opened, so that the side door 2 can be opened.

The handle body 12 includes a design surface 14, an operation surface 16 and a pair of protection walls 18. When the handle body 12 is at the ordinary position, the design surface 14 is disposed along the opening 3a of the placement surface 7a of the armrest portion 7. At this time, the design surface 14 is disposed parallel to the placement surface 7a (see FIG. 5). When the handle body 12 is at the ordinary position, the operation surface 16 extends from a distal end 14e of the design surface 14 relative to the rotation shaft X to the interior of the opening 3a. Further, the operation surface 16 forms a concave portion 20 in which a finger of the user that operates the handle body 12 is disposed. In the embodiment, the handle body 12 is disposed at a portion that is of the opening 3a and that is positioned in the first region R1. In the handle body 12, the concave portion 20 formed by the operation surface 16 is opened toward a portion that is of the opening 3a and that is positioned in the second region R2. In this configuration, when the user operates the handle body 12, the user can easily put the finger into the concave portion 20. The protection walls 18 are positioned on both right and left sides of the concave portion 20 formed by the operation surface 16. The protection walls 18 extend from the design surface 14 to the opening 3a. Distal ends 18e of the protection walls 18 relative to the rotation shaft X have an arc shape centered at the rotation shaft X, for example.

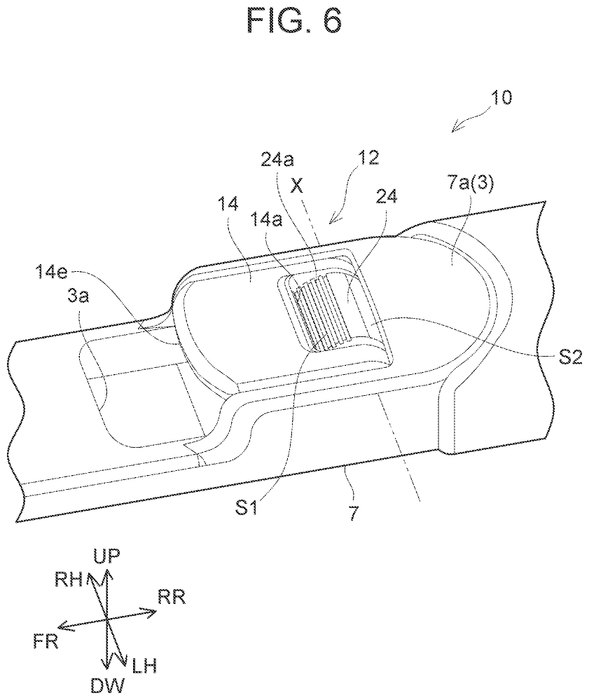

As shown mainly in FIG. 4 and FIG. 6, a knob opening 14a is formed on the design surface 14 of the handle body 12. The lock knob 24 is disposed in the interior of the knob opening 14a. For example, the lock knob 24 is a cylindrical member. The lock knob 24 is supported by the handle body 12, so as to be capable of rotating between a lock position and an unlock position. For example, when the side door 2 is closed and the handle body 12 is at the ordinary position, the lock knob 24 is rotated by the user. The lock knob 24 is connected to the lock mechanism of the side door 2 through a control cable (not illustrated). When the lock knob 24 is at the unlock position, the lock mechanism of the side door 2 is in an unlock state, and the operation of the lock mechanism by the handle body 12 is enabled. On the other hand, when the lock knob 24 is at the lock position, the lock mechanism is in a lock state, and the operation of the lock mechanism by the handle body 12 is disabled.

An outer surface 24a of the lock knob 24 includes a first range S1 and a second range S2 that have different friction coefficients from each other. The first range S1 has a non-flat surface on which a serration is formed, and the second range S2 has a flat surface. When the lock knob 24 is at the lock position, the first range S1 and the second range S2 are exposed from the knob opening 14a such that the first range S1 is positioned on the front side relative to the second range S2 (see FIG. 6). When the lock knob 24 is at the unlock position, the first range S1 and the second range S2 are exposed from the knob opening 14a such that the first range S1 is positioned on the rear side relative to the second range S2 (see FIG. 4). As an example, a mark 25 visually showing that the lock knob 24 is at the unlock position is provided in the second range S2 that is exposed from the knob opening 14a when the lock knob 24 is at the unlock position.

The lock knob 24 rotates around the rotation shaft X in common with the handle body 12. In this configuration, it is possible to reduce the number of components, and to prevent the increase in the size of the handle body 12. Without being limited to this configuration, the lock knob 24 may rotate around a rotation shaft that is disposed parallel to the rotation shaft X of the handle body 12. In this configuration, the user can easily move the finger from the lock knob 24 to the operation surface 16 of the handle body 12, without moving the orientation of the arm over a large range. However, without being limited to the above configuration, the rotation shaft of the handle body 12 and the rotation shaft of the lock knob 24 may be individually provided, or the orientations of both rotation shafts may be different from each other.

A top portion of the lock knob 24 may be disposed so as to be roughly flush with a portion where the knob opening 14a is formed, that is, the design surface 14 of the handle body 12. Thereby, it is possible to enhance the design property of the inside handle 10. Further, since the lock knob 24 does not protrude from the design surface 14, it is possible to restrain an unintentional operation of the lock knob 24.

As described above, the inside handle 10 is sometimes disposed in the opening 3a that is formed on the interior surface 3 of the side door 2. This type of inside handle 10 is operated by the user from the ordinary position where the handle body 12 is contained in the interior of the opening 3a to the operation position where the handle body 12 is displaced to the exterior of the opening 3a. In that case, when the handle body 12 is returned from the operation position to the ordinary position, the finger of the user that operates the handle body 12 can be caught between the handle body 12 and the opening 3a.

For solving the above problem, in the inside handle 10 in the embodiment, when the user operates the handle body 12, the finger of the user is disposed in the concave portion 20 formed in the handle body 12. The protection walls 18 that extend from the design surface 14 of the handle body 12 to the interior of the opening 3a are provided on both sides of the concave portion 20. In this configuration, even when the handle body 12 is operated to the operation position and the concave portion 20 of the handle body 12 is displaced to the exterior of the opening 3a, it is possible to avoid a gap by which the finger of the user can be caught, from being formed between the handle body 12 and the opening 3a.

In the inside handle 10 in the embodiment, the distal ends 18e of the protection walls 18 relative to the rotation shaft X have an arc shape centered at the rotation shaft X. In this configuration, it is possible to avoid the gap from being formed between the handle body 12 and the opening 3a, regardless of the position of the swinging of the handle body 12. However, as another embodiment, the distal ends 18e of the protection walls 18 may have a straight line or flexion line shape that is similar to an arc shape centered at the rotation shaft X.

In the inside handle 10 in the embodiment, the opening 3a formed on the interior surface 3 is opened upward, and the rotation shaft X of the handle body 12 is parallel to the right-left direction of the vehicle. In this case, it is possible to provide the inside handle 10 on the armrest portion 7 as in the case of the embodiment. However, the inside handle 10 may be provided at another portion of the interior surface 3 of the side door 2. The orientation in which the opening 3a formed on the interior surface 3 is opened and the orientation in which the rotation shaft X of the handle body 12 is disposed may be changed depending on the position where the inside handle 10 is provided.

In the inside handle 10 in the embodiment, the outer surface 24a of the lock knob 24 includes the first range S1 and the second range S2 that have different friction coefficients from each other. As described above, when the lock knob 24 is at the lock position, the first range S1 and the second rage S2 are exposed such that the first range S1 is positioned on one side relative to the second range S2. When the lock knob 24 is at the unlock position, the first range S1 and the second range S2 are exposed such that the first range S1 is positioned on the other side relative to the second range S2. Thereby, the user can recognize the position of the lock knob 24 by tactile sense, without visually recognizing the lock knob 24. Further, the range (the first range S1 in the embodiment) having the higher friction coefficient is constantly exposed regardless of the position of the lock knob 24, and therefore it is hard for finger slippage to occur at the time of operation.

In the embodiment, the serration is formed in the first range S1 of the outer surface 24a. Instead of or in addition to this, a plurality of concave portions or convex portions may be formed so as to be scattered, in the first range S1. Even this configuration allows the friction coefficient of the first range S1 to be higher than the friction coefficient of the second range S2. Alternatively, in addition to or instead of the surface shapes, the material may be different between the first range S1 and the second range S2. Even this configuration allows the friction coefficient of the first range S1 to be higher than the friction coefficient of the second range S2.

Specific examples of the technology disclosed in the present specification have been described above in detail. However, the specific examples are just examples, and do not limit the claims. The technology described in the claims includes various modifications and alterations of the above-described specific examples. Technical elements described in the present specification or drawings exert technical utilities independently or by various combinations, and are not limited to combinations described in the claims at the filing time. Further, the technology exemplified in the present specification or drawings can concurrently achieve a plurality of purposes, and has a technical utility simply by achieving one of the purposes.

What is claimed is:

1. An inside handle that is provided on a door of a vehicle,
the inside handle comprising:
a handle body that is disposed in an opening formed on an interior surface of the door and that is operated by a user; and
a handle base that supports the handle body such that the handle body is capable of swinging around a rotation shaft parallel to the opening between an ordinary position and an operation position, the ordinary position being a position where the handle body is contained in the opening, the operation position being a position where the handle body is displaced from the ordinary position to an exterior of the opening, wherein
the handle body includes:
a design surface that is disposed along the opening when the handle body is at the ordinary position;
an operation surface that extends from a distal end of the design surface relative to the rotation shaft to an interior of the opening, the operation surface forming a concave portion in which a finger of the user that operates the handle body is disposed; and
a pair of protection walls that is positioned on both sides of the concave portion formed by the operation surface and that extends from the design surface to the interior of the opening.

2. The inside handle according to claim 1, wherein distal ends of the protection walls relative to the rotation shaft have an arc shape centered at the rotation shaft.

3. The inside handle according to claim 1, wherein:
the interior surface includes a first region and a second region that protrudes relative to the first region;
the opening is formed across the first region and the second region; and
the handle body is disposed at a portion that is of the opening and that is positioned in the first region, and the concave portion formed by the operation surface is opened toward a portion that is of the opening and that is positioned in the second region.

4. The inside handle according to claim 1, wherein:
the opening formed on the interior surface is opened upward; and
the rotation shaft is parallel to a right-left direction of the vehicle.

5. The inside handle according to claim 1, wherein:
the inside handle further comprises a lock knob that is supported so as to be capable of rotating between a lock position and an unlock position;
a surface of the lock knob includes a first range and a second range that have different friction coefficients from each other;
when the lock knob is at the lock position, the first range and the second range are exposed such that the first range is positioned on one side relative to the second range; and
when the lock knob is at the unlock position, the first range and the second range are exposed such that the first range is positioned on the other side relative to the second range.
